(19) United States
(12) Patent Application Publication
(10) Pub. No.: US 2015/0120908 A1
(43) Pub. Date: Apr. 30, 2015

(54) REAL-TIME, DISTRIBUTED ADMINISTRATION OF INFORMATION DESCRIBING DEPENDENCY RELATIONSHIPS AMONG CONFIGURATION ITEMS IN A DATA CENTER

(71) Applicant: International Business Machines Corporation, Armonk, NY (US)

(72) Inventors: ERIC M. ANDERSON, FRIENDSWOOD, TX (US); CHRISTOPHER J. DAWSON, ARLINGTON, VA (US); RAJESH RADHAKRISHNAN, RESTON, VA (US); CAROL S. WALTON, CEDAR PARK, TX (US)

(73) Assignee: International Business Machines Corporation, Armonk, NY (US)

(21) Appl. No.: 14/066,150

(22) Filed: Oct. 29, 2013

(51) Int. Cl. H04L 12/24

(52) U.S. Cl. CPC H04L 41/0853
USPC 709/224

(57) ABSTRACT

In a data center, real-time, distributed administration of information describing dependency relationships among configuration items may be carried out. In such a data center, each configuration item is associated with an independent agent that is coupled to other agents and maintains a record of dependencies amongst the configuration item associated with the agent and other configuration items. Administration of dependency information includes: detecting, by an independent agent associated with a particular configuration item, a change in the item's dependency; providing information describing the change in the particular configuration item's dependency to all other independent agents associated with configuration items that are in a dependency relationship with the particular configuration item; and, for each of the other independent agents associated with configuration items that are in a dependency relationship with the particular configuration item: updating the record of dependences for the configuration item associated with the independent agent.

### BACKGROUND OF THE INVENTION

1. Field of the Invention

The field of the invention is data processing, or, more specifically, methods, apparatus, and products for real-time, distributed administration of information describing dependency relationships among configuration items of a data center.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

Enterprise data centers today may include many hundreds or thousands of computers. The computers may take on various forms: servers, workstations, virtual machine hosts, and so on. Such computers may be coupled for data communications through various networks and network devices. Storage devices may be coupled for use by the computers either directly to the computers or through network connections.

Various management devices may be included in the network. From time to time and for various reasons, one or more of these devices (computers, network devices, etc) or may be changed in some way. Such changes may include replacing the device, modifying the devices firmware, modifying the applications running on the device, adding additional devices to the network, and so on.

Change Management is a process by which understanding the effects of a change is attempted in order to provide proper planning and risk avoidance. Knowing that if one system is taken down, another system will be affected is essential to quality impact analysis. Today, much of this analysis is accomplished based on a system administrator's prior knowledge of the environment or by a complex, time consuming deployments of scanning utilities. In both cases, data describing the current relationships can become out of date rapidly as changes can occur between scans or without the knowledge of the system administrator.

### SUMMARY OF THE INVENTION

Methods, apparatus, and products for real-time, distributed administration of information describing dependency relationships among configuration items of a data center are disclosed. Each configuration item of the data center is associated with an independent agent. The independent agents are coupled to one another for data communications and each independent agent maintains a record of dependencies amongst the configuration item associated with the independent agent and other configuration items of the data center. In such an environment, administration of information describing dependency relationships may include: detecting, by an independent agent associated with a particular configuration item, a change in the configuration item's dependency, including updating a record of dependencies for the particular configuration item; providing, by the independent agent associated with the particular configuration item, information describing the change in the particular configuration item's dependency to all other independent agents associated with configuration items that are in a dependency relationship with the particular configuration item; and for each of the other independent agents associated with configuration items that are in a dependency relationship with the particular configuration item: updating, by the independent agent, the record of dependences for the configuration item associated with the independent agent.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram of a data center configured for real-time, distributed administration of information describing dependency relationships among configuration items according to embodiments of the present invention.

FIG. 2 sets forth a block diagram of automated computing machinery comprising an exemplary computer (152) useful in real-time, distributed administration of information describing dependency relationships among configuration items of a data center according to embodiments of the present invention.

FIG. 3 sets forth a functional block diagram of an example system configured for real-time, distributed administration of information describing dependency relationships among configuration items of a data center according to embodiments of the present invention.

FIG. 4 sets forth a flow chart illustrating an example method for real-time, distributed administration of information describing dependency relationships among configuration items of a data center according to embodiments of the present invention.

FIG. 5 sets forth a flow chart illustrating a further exemplary method for real-time, distributed administration of information describing dependency relationships among configuration items of a data center according to embodiments of the present invention.

FIG. 6 sets forth a flow chart illustrating a further exemplary method for real-time, distributed administration of information describing dependency relationships among configuration items of a data center according to embodiments of the present invention.

FIG. 7 sets forth a flow chart illustrating a further exemplary method for real-time, distributed administration of information describing dependency relationships among configuration items of a data center according to embodiments of the present invention.

### DETAILED DESCRIPTION OF EXEMPLARY EMBODIMENTS

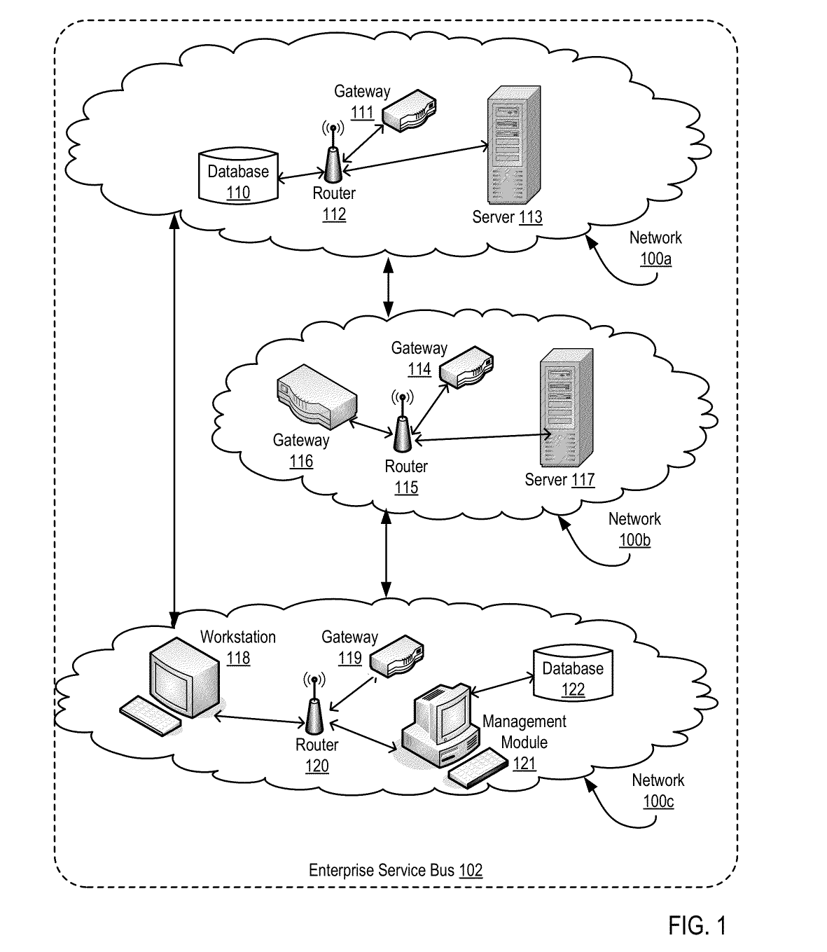

Exemplary methods, apparatus, and products for real-time, distributed administration of information describing dependency relationships among configuration items of a data center in accordance with the present invention are described with reference to the accompanying drawings, beginning with FIG. 1. FIG. 1 sets forth a network diagram of a data center configured for real-time, distributed administration of information describing dependency relationships among configuration items according to embodiments of the present invention.

A ‘configuration item’ as the term is used in this specification refers to any device or software module in a data center that may be dependent upon another device or software module or is depended upon by another device or software module. Examples of such configuration items depicted in the system of FIG. 1 include gateways (111, 114, 119), databases (110, 122), routers (112, 115, 120), workstation (118), servers (113, 117) and the management module (121).

Each of the configuration items may be in a dependency relationship with another configuration item. In the data center of FIG. 1, as just one example, the database (110) may be dependent upon the router (112) which may be dependent upon the gateway (111). The term ‘dependency relationship’ as used in this specification refers to a relationship between two configuration items, where at least one of the items is dependent upon the other. ‘Dependency’ and ‘dependency relationship’ may refer to dependency in several directions. That is, the term ‘dependency’ here may refer to a particular configuration item's dependency on another configuration item, another configuration item's dependency on the particular configuration item, or a co-dependency between the two configuration items. Such dependencies may take various forms. For example, a workstation may dependent upon a router because the workstation is coupled through a data communications cable to the router at a particular port. Replacing the router with another router (a router, for example, with different firmware or routing capabilities), may be a change in dependency status from the perspective of the workstation.

The system of FIG. 1 includes several networks (100a, 110b, 100c) that couple the configuration items of FIG. 1 for data communications. Each configuration item of the data center is associated with an independent agent. The term independent agent refers to a module of computer program instructions that when executed maintains a record of dependencies amongst the configuration item associated with the independent agent and other configuration items of the data center in accordance with embodiments of the present invention. The maintenance of the dependency record is independent from other agents' maintenance. A configuration item is said to be “associated with” an independent agent in that the independent agent maintains the dependency relationship information for only one configuration item. The independent agent may be a software module executed by the configuration item or executed by another module of automated computing machinery but in data communications with the configuration item.

In the example of FIG. 1, the independent agents are not shown but can be thought of as running as a software module on each of the configuration items of FIG. 1. As such, the independent agents are coupled to one another for data communications. In the example of FIG. 1, the independent agents are coupled to one another for data communications through an enterprise service bus (102). An enterprise service bus is a software architecture for middleware that provides fundamental services for more complex architectures. In essence, higher-level software modules utilize the enterprise service bus for data communications exchanges without any specialized configuration for such data communications. Instead, such higher-level software modules, which would normally be unable to communicate with one another without specialization, need only be configured to communicate with the enterprise service bus, which is in turn configured to pass along the data communications to the intended end-point. In this way, the enterprise service bus abstracts the complexities of communication from higher-level software modules. As explained below in further detail, the enterprise service bus may be implemented with a single instance of middleware executing on each configuration item.

Further, the enterprise service bus supports a publish-subscribe (‘Pub/Sub’) architecture where senders of messages, called publishers, do not program the messages to be sent directly to specific receivers, called subscribers. Instead, published messages are characterized into classes, without knowledge of what, if any, subscribers there may be. Similarly, subscribers express interest in one or more classes, and only receive messages that are of interest, without knowledge of what, if any, publishers there are.

In the example of FIG. 1, real-time, distributed administration of information describing dependency relationships among configuration items of a data center may be carried out by detecting, by an independent agent associated with a particular configuration item, a change in the configuration item's dependency. Consider, for example, that the independent agent of the gateway (111) detects a change in the gateway's dependencies. Such a change may exist by a change in the gateway's connection to another network (110b, for example). The independent agent of the gateway (111) may then update the gateway's (111) record of dependencies and provide information describing the change to all other independent agents associated with configuration items that are in a dependency relationship with the particular configuration item. In the example of FIG. 1, the independent agent may publish the change via the enterprise service bus (102), where the independent agents of each configuration item in a dependency relationship with the gateway—such as the router (112) and database (110)—may be subscribed to receive any such changes.

Each of the other independent agents associated with configuration items that are in a dependency relationship with the gateway, upon receipt of the updated change information may then update their record of dependences. In this way, such changes are updated in real-time (or near real-time) without the use of a centralized system or distribution of specialized scanning utilities.

The system of FIG. 1 also includes a management module (121) which may be configured to perform various management tasks with respect to the configuration items in the example of FIG. 1. Although the management module is not utilized in the example of FIG. 1 to maintain a current (or near-current) status of all dependency information in the data center, the management module (121) may be configured to perform various other tasks based on the dependency information. For example, the management module (121) may be configured to send, to any one of the independent agents of FIG. 1, a request for information describing the dependency relationships of configuration items associated with the independent agents and receive, as a response to the request from the independent agents, a record of dependences for the configuration items. In some embodiments, the management module may fine-tune a request for a particular configuration item such that the independent agent is asked for information regarding only configuration items depended upon by the particular configuration or, alternatively, asked for information regarding only configuration items that the particular configuration item depends upon. Such requests may be published via the enterprise service bus (102).

In some embodiments, the management module (121) may also be configured to broadcast a similar request to all the independent agents in the data center. In this way, the management module (121) may, periodically or at the behest of a system administrator, gather all dependency relationships in the data center and maintain a data center-wide view of the dependency relationships amongst configuration items.

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

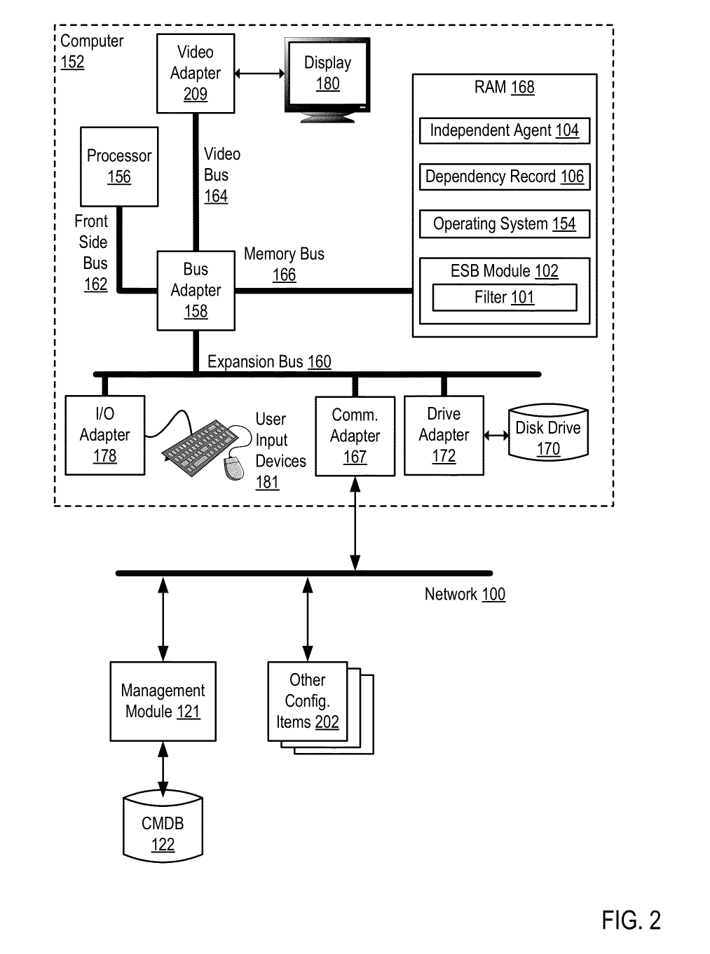

Real-time, distributed administration of information describing dependency relationships among configuration items of a data center in accordance with embodiments of the present invention is generally implemented with computers, that is, with automated computing machinery. In the system of FIG. 1, for example, all the configuration items may be implemented to some extent at least as computers. For further explanation, therefore, FIG. 2 sets forth a block diagram of automated computing machinery comprising an exemplary computer (152) useful in real-time, distributed administration of information describing dependency relationships among configuration items of a data center according to embodiments of the present invention. The computer (152) of FIG. 2 includes at least one computer processor (156) or ‘CPU’ as well as random access memory (168) (‘RAM’) which is connected through a high speed memory bus (166) and bus adapter (158) to processor (156) and to other components of the computer (152).

Stored in RAM (168) is an independent agent (104), a module of computer program instructions that, when executed, causes the computer (152) to operate in support of real-time, distributed administration of information describing dependency relationships among configuration items of a data center in accordance with embodiments of the present invention. The computer (152) itself is an example of such a configuration item. The computer (152) is coupled to other configuration items (202) through a data communications network (100).

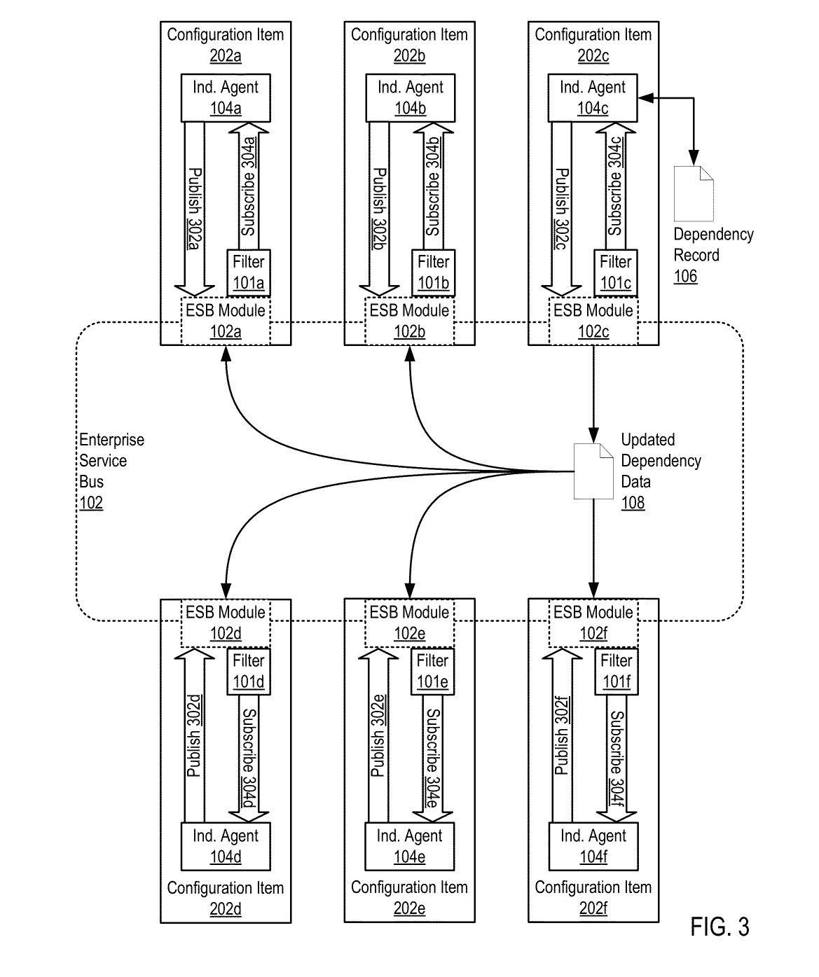

Each of the configuration items is associated with an independent agent (104). Each of the independent agents (104) maintain a record (106) of dependencies amongst the configuration item associated with the independent agent and other configuration items of the data center. The independent agents are also coupled to one another for data communications. In the example of FIG. 2, the independent agents (104) are coupled for data communications through an enterprise service bus (ESB), implemented by an ESB module (102) executing on each of the configuration items. Each ESB module supports a Pub/Sub data communications protocol through the use of filters (101), described in greater detail below with respect to FIG. 3.

The independent agent (104) in the example of FIG. 2 is configured to detect a change in the computer's (152) dependency and update the record (106) of dependencies for the computer. The change may be the result of any number of things including for example, updated firmware, an updated operating system, a change in hardware (due to a fault, an upgrade, or addition of hardware), change in data communication couplings, and so on as will occur to readers of skill in the art.

The independent agent (104) may then provide information describing the change in the computer's (152) dependency to all other independent agents associated with configuration items that are in a dependency relationship with the particular configuration item. The independent agent (104) may provide this information through the ESB module (102) in a broadcast to all other ESB modules. Only ESB modules of configuration items having a filter (101) set to accept messages from the independent agent (104)—those ESB modules coupled to an independent agent that is subscribed to the computer's (152) independent agent (104)—will pass along the message through the filter.

Each of the other independent agents associated with configuration items that are in a dependency relationship with the computer (152) is configured to update the record of dependences for the configuration item associated with the independent agent. That is, each independent agent receiving the updated dependency information updates their corresponding record of dependencies.

The computer (152) is also coupled through the data communications network (100) to a management module (121) which maintains a configuration management database (122). The configuration management database may be updated from time to time (either periodically or at the behest of a user) by retrieving current dependency relationship information from configuration items in the data center.

Also stored RAM (168) of the computer (152) is an operating system (154). Operating systems useful real-time, distributed administration of information describing dependency relationships among configuration items of a data center according to embodiments of the present invention include UNIX™, Linux™, Microsoft XP™, AIX™, IBM's i5/OS™, and others as will occur to those of skill in the art. The operating system (154), independent agent (104), and ESB module (102) in the example of FIG. 2 are shown in RAM (168), but many components of such software typically are stored in non-volatile memory also, such as, for example, on a disk drive (170).

The computer (152) of FIG. 2 includes disk drive adapter (172) coupled through expansion bus (160) and bus adapter (158) to processor (156) and other components of the computer (152). Disk drive adapter (172) connects non-volatile data storage to the computer (152) in the form of disk drive (170). Disk drive adapters useful in computers for real-time, distributed administration of information describing dependency relationships among configuration items of a data center according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computer (152) of FIG. 2 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example computer (152) of FIG. 2 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary computer (152) of FIG. 2 includes a communications adapter (167) for data communications with other computers (182) and for data communications with a data communications network (100). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for real-time, distributed administration of information describing dependency relationships among configuration items of a data center according to embodiments of the present invention include modems for wired dial-up communications, Ethernet (IEEE 802.3) adapters for wired data communications, and 802.11 adapters for wireless data communications.

For further explanation, FIG. 3 sets forth a functional block diagram of an example system configured for real-time, distributed administration of information describing dependency relationships among configuration items of a data center according to embodiments of the present invention. The example system of FIG. 3 includes six configuration items (202a, 202b, 202c, 202d, 202e, 202f). Each configuration item (202) is associated with an independent agent (104a, 104b, 104c, 104d, 104e, 104f). In the example of FIG. 3, the independent agents (104) are coupled to one another for data communications through an enterprise service bus (102) and data communications networks implemented with hardware and software not shown in the example of FIG. 3.

The example enterprise service bus (102) of FIG. 3 is shown in its logical form, being implemented with a plurality of ESB modules (102a, 102b, 102c, 102d, 102e, 1020, where each different module executes on a different configuration item (202). The ESB modules implement an ESB (102) configured to provide a publish/subscribe architecture and protocol that supports communications amongst the independent agents. Each ESB module implements a filter (101a, 101b, 101c, 101d, 101e, 1010 that the ESB module uses to determine whether to pass along message received from other ESB modules to the independent agent. Each filter (101a-101f) includes a list of message senders that the independent agent is subscribed to. When a message is received by the ESB module, the ESB module determines whether the sender of the message is included in the list of the filter. If so, the ESB module passes the message along to the independent agent. If not, the ESB module ignores the message and does not pass the message along to the independent agent.

Each independent agent (104a-104f) maintains a dependency record (106). One dependency record is displayed for purposes of clarity, but readers will understand that each independent agent maintains a separate dependency record. The dependency record indicates dependencies amongst the configuration item (202a-202f) associated with the independent agent (104a-104f) and other configuration items of the data center.

In the example system of FIG. 3, an independent agent (104c) detects a change in the configuration item's (202c) dependency. Such a change may include the removal of a dependency on another item, the addition of a dependency on another item, or the like. In response, the independent agent updates the record (106) of dependencies for the particular configuration item (202c). In the example of FIG. 3, updating the record (106) of dependencies may also include updating the filter (101c) maintained by the ESB module (102c) such that the filter enables communications to be passed along to the independent agent (104c) only from those configuration items having a dependency relationship with the configuration item (202c).

Also responsive to detecting the change in dependency, the independent agent (104c) provides information (108) describing the change in the particular configuration item's dependency to all other independent agents associated with configuration items that are in a dependency relationship with the particular configuration item. That is, the independent agent (104c) publishes (302) on the enterprise service bus (102) through the ESB module (102c), updated dependency data (108).

Based on the filters (101b), each ESB module (102b) determines whether to pass along the updated dependency data (108) to the corresponding independent agent. The independent agents associated with configuration items having a dependency relationship with the configuration item (202c) will be provided the updated dependency data (101) by their ESB module (102).

Each of the other independent agents (104) associated with configuration items that are in a dependency relationship with the particular configuration item receive the message, then update the record of dependences for the configuration item associated with the independent agent. Consider, for example, that the independent agent (104b) is associated with a configuration item (202b) that has dependency relationship with the configuration item (202c). When the ESB module (102b) of the configuration item (202b) receives the updated dependency data (108) from the configuration item (202c), the ESB module (102b) discovers the dependency relationship from the filter (101b) and passes the data (108) to the independent agent which then updates its own records accordingly.

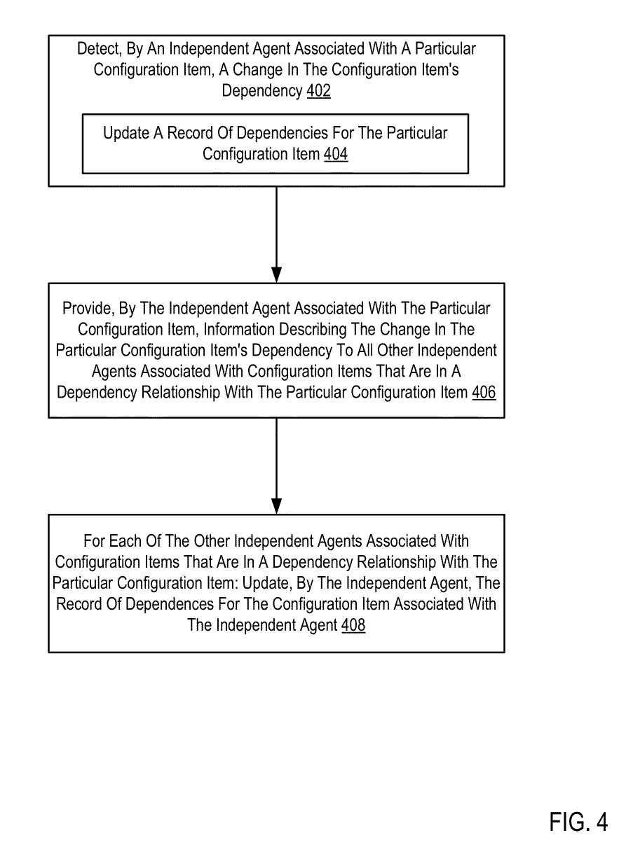

For further explanation FIG. 4 sets forth a flow chart illustrating an example method for real-time, distributed administration of information describing dependency relationships among configuration items of a data center according to embodiments of the present invention. The method of FIG. 4 may be carried out in a system similar to that depicted in the example of FIG. 1, 2, or 3 where each configuration item of the data center is associated with an independent agent. The independent agents are coupled to one another for data communications. Each independent agent maintains a record of dependencies amongst the configuration item associated with the independent agent and other configuration items of the data center.

The method of FIG. 4 includes detecting (402), by an independent agent associated with a particular configuration item, a change in the configuration item's dependency. In the method of FIG. 4, detecting (402) a change in the configuration item's dependency includes updating (404) a record of dependencies for the particular configuration item. The change may be the result of any number of things including for example, updated firmware, an updated operating system, a change in hardware (due to a fault, an upgrade, or addition of hardware), change in data communication couplings, and so on as will occur to readers of skill in the art.

The method of FIG. 4 also includes providing (406), by the independent agent associated with the particular configuration item, information describing the change in the particular configuration item's dependency to all other independent agents associated with configuration items that are in a dependency relationship with the particular configuration item. Providing (406) information describing the change may be carried out in a variety of ways including through out-of-band data communications among the independent agents, through in-band data communications, and through other types of data communications protocols.

For each of the other independent agents associated with configuration items that are in a dependency relationship with the particular configuration item, the method of FIG. 4 continues by updating (408), by the independent agent, the record of dependences for the configuration item associated with the independent agent. Such records may be implemented in a variety of forms. One form in which the record may be implemented is an eXtensible Markup Language (XML) document, where each record is represented as an element in the XML document and one or more attributes of an XML element may be modified to reflect the change in dependency.

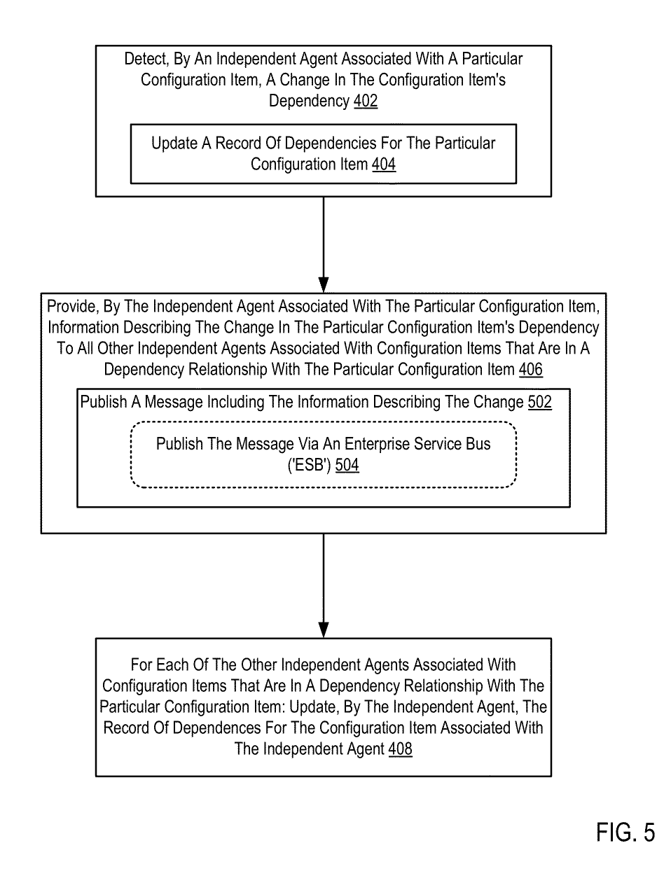

For further explanation, FIG. 5 sets forth a flow chart illustrating a further exemplary method for real-time, distributed administration of information describing dependency relationships among configuration items of a data center according to embodiments of the present invention. The method of FIG. 5 is similar to the method of FIG. 4 in that the method of FIG. 5 includes detecting (402) a change in the configuration item's dependency; providing (406) information describing the change in the particular configuration item's dependency to all other independent agents associated with configuration items that are in a dependency relationship with the particular configuration item; and updating (408), by each of those independent agents, the record of dependences for the configuration item associated with the independent agent.

The method FIG. 5 differs from the method of FIG. 4, however, in that in the method of FIG. 5 the independent agents are coupled to one another for data communications via a publish/subscribe (pub/sub) data communications protocol. IN such a pub/sub data communications protocol, each independent agent subscribes to messages from other independent agents associated with configuration items in a dependency relationship with the configuration item associated with the independent agent.

Also in the method of FIG. 5, providing (406) information describing the change in the particular configuration item's dependency to all other independent agents associated with configuration items that are in a dependency relationship with the particular configuration item is carried out by publishing (502) a message including the information describing the change. In the method of FIG. 5, publishing (502) a message including the information describing the change may be carried out by publishing (504) the message via an enterprise service bus as described above with respect to FIG. 3.

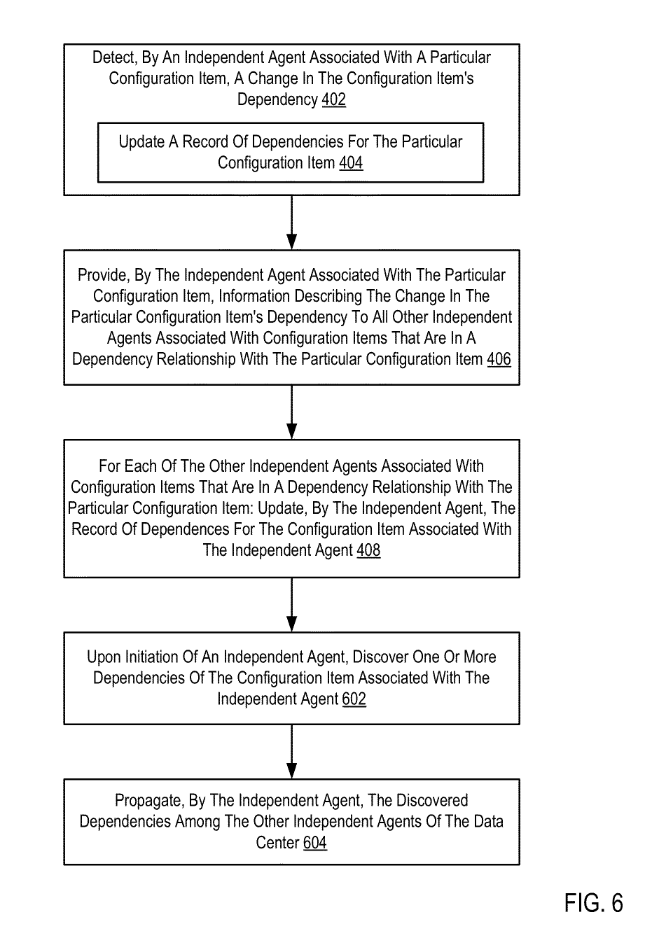

For further explanation, FIG. 6 sets forth a flow chart illustrating a further exemplary method for real-time, distributed administration of information describing dependency relationships among configuration items of a data center according to embodiments of the present invention. The method of FIG. 6 is similar to the method of FIG. 4 in that the method of FIG. 6 includes detecting (402) a change in the configuration item's dependency; providing (406) information describing the change in the particular configuration item's dependency to all other independent agents associated with configuration items that are in a dependency relationship with the particular configuration item; and updating (408), by each of those independent agents, the record of dependences for the configuration item associated with the independent agent.

The method FIG. 6 differs from the method of FIG. 4, however, in that the method of FIG. 6 includes discovering (602), upon initiation of an independent agent, one or more dependencies of the configuration item associated with the independent agent. Such a discovery (602) may be carried out in a variety of ways. For example, configuration files may be available to the independent agent upon startup, where the configuration files describe the configuration item along with dependency relationship between the configuration item and other items. In another example, the independent agent may perform various discovery techniques, such as traceroutes and the like, to identify data communications dependencies.

The method of FIG. 6 also includes propagating (604), by the independent agent, the discovered dependencies among the other independent agents of the data center. Such a propagation (604) may be carried out by publishing the discovered dependencies on an enterprise service bus. Such discovery (602) and propagation (604) may be utilized at the time dependencies are first created in the data center. That is, the discovery and propagation may be utilized to begin recording dependencies.

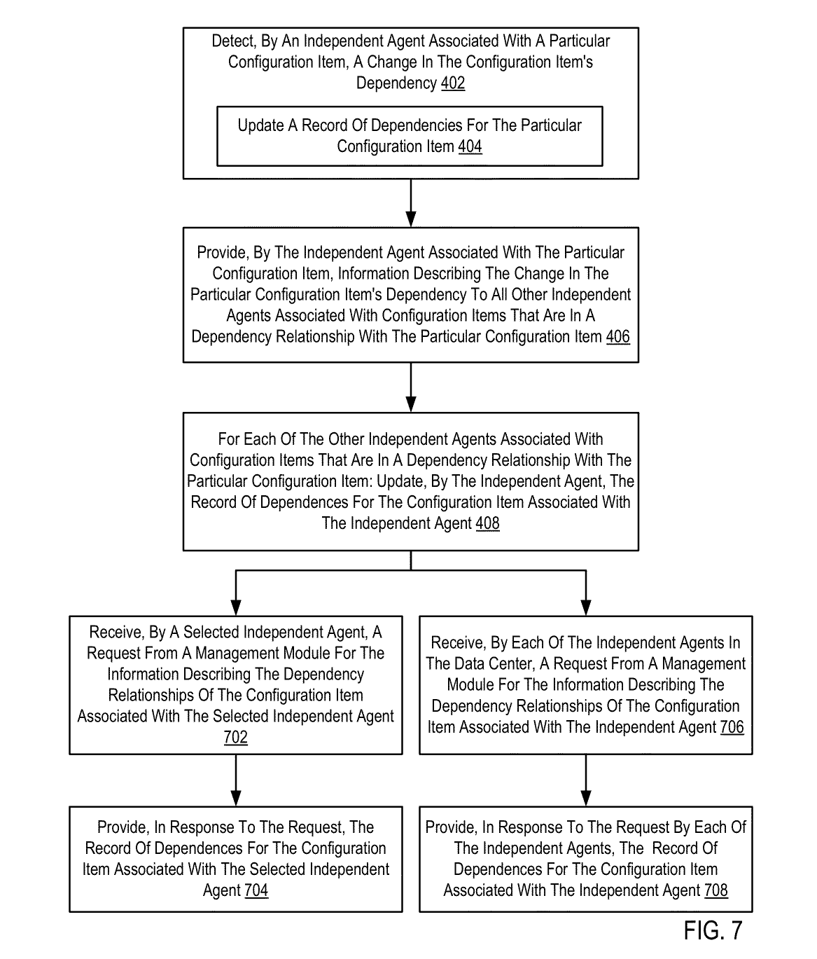

For further explanation, FIG. 7 sets forth a flow chart illustrating a further exemplary method for real-time, distributed administration of information describing dependency relationships among configuration items of a data center according to embodiments of the present invention. The method of FIG. 7 is similar to the method of FIG. 4 in that the method of FIG. 7 includes detecting (402) a change in the configuration item's dependency; providing (406) information describing the change in the particular configuration item's dependency to all other independent agents associated with configuration items that are in a dependency relationship with the particular configuration item; and updating (408), by each of those independent agents, the record of dependences for the configuration item associated with the independent agent.

The method FIG. 7 differs from the method of FIG. 4, however, in that the method of FIG. 7 includes receiving (702), by a selected independent agent, a request from a management module for the information describing the dependency relationships of the configuration item associated with the selected independent agent and providing (704), in response to the request, the record of dependences for the configuration item associated with the selected independent agent. Here, a management module may request dependency relationship information from a single selected independent agent. Such a request may be initiated by a user. Consider, for example, that a system administrator intends to replace a currently installed router with a different router. The system administrator may request dependency information from the currently installed router to identify other configuration items which may be affected by the replacement.

The method of FIG. 7 also includes receiving (706), by each of the independent agents in the data center, a request from a management module for the information describing the dependency relationships of the configuration item associated with the independent agent and providing (708), in response to the request by each of the independent agents, the record of dependences for the configuration item associated with the independent agent. Here, a management module may request dependency information from all the independent agents in the data center. In this way, the management module may retrieve all current dependency information. Such a request may be carried out on a periodic schedule so that the management module may maintain an up-to-date version of dependency information data center wide. Alternatively, the request may be initiated at the behest of a system administer to have the most up-to-date information available.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of real-time, distributed administration of information describing dependency relationships among configuration items of a data center, each configuration item of the data center associated with an independent agent, the independent agents coupled to one another for data communications, each independent agent maintaining a record of dependencies amongst the configuration item associated with the independent agent and other configuration items of the data center, the method comprising:
detecting, by an independent agent associated with a particular configuration item, a change in the configuration item's dependency, including updating a record of dependencies for the particular configuration item;
providing, by the independent agent associated with the particular configuration item, information describing the change in the particular configuration item's dependency to all other independent agents associated with configuration items that are in a dependency relationship with the particular configuration item; and
for each of the other independent agents associated with configuration items that are in a dependency relationship with the particular configuration item:
updating, by the independent agent, the record of dependences for the configuration item associated with the independent agent.

2. The method of claim 1 wherein:
the independent agents are coupled to one another for data communications via a publish/subscribe (pub/sub) data communications protocol, wherein each independent agent subscribes to messages from other independent agents associated with configuration items in a dependency relationship with the configuration item associated with the independent agent; and
providing, by the independent agent associated with the particular configuration item, information describing the change in the particular configuration item's dependency to all other independent agents associated with configuration items that are in a dependency relationship with the particular configuration item further comprises publishing a message including the information describing the change.

3. The method of claim 2 wherein the pub/sub data communications protocol is carried out by an enterprise service bus (‘ESB’).

4. The method of claim 1 further comprising:
upon initiation of an independent agent, discovering one or more dependencies of the configuration item associated with the independent agent; and
propagating, by the independent agent, the discovered dependencies among the other independent agents of the data center.

5. The method of claim 1 further comprising:
receiving, by a selected independent agent, a request from a management module for the information describing the dependency relationships of the configuration item associated with the selected independent agent; and
providing, in response to the request, the record of dependences for the configuration item associated with the selected independent agent.

6. The method of claim 1 further comprising:
receiving, by each of the independent agents in the data center, a request from a management module for the information describing the dependency relationships of the configuration item associated with the independent agent; and
providing, in response to the request by each of the independent agents, the record of dependences for the configuration item associated with the independent agent.

7. An apparatus for real-time, distributed administration of information describing dependency relationships among configuration items of a data center, each configuration item of the data center associated with an independent agent, the independent agents coupled to one another for data communications, each independent agent maintaining a record of dependencies amongst the configuration item associated with the independent agent and other configuration items of the data center, the apparatus comprising a computer processor, a computer memory operatively coupled to the computer processor, the computer memory having disposed within it computer program instructions that, when executed by the computer processor, cause the apparatus to carry out the steps of:
detecting, by an independent agent associated with a particular configuration item, a change in the configuration item's dependency, including updating a record of dependencies for the particular configuration item;
providing, by the independent agent associated with the particular configuration item, information describing the change in the particular configuration item's dependency to all other independent agents associated with configuration items that are in a dependency relationship with the particular configuration item; and
for each of the other independent agents associated with configuration items that are in a dependency relationship with the particular configuration item:
updating, by the independent agent, the record of dependences for the configuration item associated with the independent agent.

8. The apparatus of claim 7 wherein:
the independent agents are coupled to one another for data communications via a publish/subscribe (pub/sub) data communications protocol, wherein each independent agent subscribes to messages from other independent agents associated with configuration items in a dependency relationship with the configuration item associated with the independent agent; and
providing, by the independent agent associated with the particular configuration item, information describing the change in the particular configuration item's dependency to all other independent agents associated with configuration items that are in a dependency relationship with the particular configuration item further comprises publishing a message including the information describing the change.

9. The apparatus of claim 8 wherein the pub/sub data communications protocol is carried out by an enterprise service bus (‘ESB’).

10. The apparatus of claim 7 further comprising computer program instructions that, when executed by the computer processor, cause the apparatus to carry out the steps of:
upon initiation of an independent agent, discovering one or more dependencies of the configuration item associated with the independent agent; and
propagating, by the independent agent, the discovered dependencies among the other independent agents of the data center.

11. The apparatus of claim 7 further comprising computer program instructions that, when executed by the computer processor, cause the apparatus to carry out the steps of:
receiving, by a selected independent agent, a request from a management module for the information describing the dependency relationships of the configuration item associated with the selected independent agent; and
providing, in response to the request, the record of dependences for the configuration item associated with the selected independent agent.

12. The apparatus of claim 7 further comprising computer program instructions that, when executed by the computer processor, cause the apparatus to carry out the steps of:
receiving, by each of the independent agents in the data center, a request from a management module for the information describing the dependency relationships of the configuration item associated with the independent agent; and
providing, in response to the request by each of the independent agents, the record of dependences for the configuration item associated with the independent agent.

13. A computer program product for real-time, distributed administration of information describing dependency relationships among configuration items of a data center, each configuration item of the data center associated with an independent agent, the independent agents coupled to one another for data communications, each independent agent maintaining a record of dependencies amongst the configuration item associated with the independent agent and other configuration items of the data center, the computer program product disposed upon a computer readable medium, the computer program product comprising computer program instructions that, when executed, cause a computer to carry out the steps of:
detecting, by an independent agent associated with a particular configuration item, a change in the configuration item's dependency, including updating a record of dependencies for the particular configuration item;
providing, by the independent agent associated with the particular configuration item, information describing the change in the particular configuration item's dependency to all other independent agents associated with configuration items that are in a dependency relationship with the particular configuration item; and
for each of the other independent agents associated with configuration items that are in a dependency relationship with the particular configuration item:
updating, by the independent agent, the record of dependences for the configuration item associated with the independent agent.

14. The computer program product of claim 13 wherein:
the independent agents are coupled to one another for data communications via a publish/subscribe (pub/sub) data communications protocol, wherein each independent agent subscribes to messages from other independent agents associated with configuration items in a dependency relationship with the configuration item associated with the independent agent; and
providing, by the independent agent associated with the particular configuration item, information describing the change in the particular configuration item's dependency to all other independent agents associated with configuration items that are in a dependency relationship with the particular configuration item further comprises publishing a message including the information describing the change.

15. The computer program product of claim 14 wherein the pub/sub data communications protocol is carried out by an enterprise service bus (TSB).

16. The computer program product of claim 13 further comprising computer program instructions that, when executed, cause a computer to carry out the steps of:
upon initiation of an independent agent, discovering one or more dependencies of the configuration item associated with the independent agent; and
propagating, by the independent agent, the discovered dependencies among the other independent agents of the data center.

17. The computer program product of claim 13 further comprising computer program instructions that, when executed, cause a computer to carry out the steps of:
receiving, by a selected independent agent, a request from a management module for the information describing the dependency relationships of the configuration item associated with the selected independent agent; and
providing, in response to the request, the record of dependences for the configuration item associated with the selected independent agent.

18. The computer program product of claim 13 further comprising computer program instructions that, when executed, cause a computer to carry out the steps of:
receiving, by each of the independent agents in the data center, a request from a management module for the information describing the dependency relationships of the configuration item associated with the independent agent; and
providing, in response to the request by each of the independent agents, the record of dependences for the configuration item associated with the independent agent.

19. The computer program product of claim 13 wherein the computer readable medium comprises a signal medium.

20. The computer program product of claim 13 wherein the computer readable medium comprises a storage medium.
